(19) United States
(12) Patent Application Publication
(10) Pub. No.: US 2004/0193521 A1
(43) Pub. Date: Sep. 30, 2004

(54) Method and system for restructuring a debt instrument without retiring underlying debt

(76) Inventors: Scott D. Smith, Rye Brook, NY (US); Timothy J. Sheehan, Zionsville, IN (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/712,481

(22) Filed: Nov. 13, 2003

Related U.S. Application Data
(60) Provisional application No. 60/425,887, filed on Nov. 13, 2002.

(51) Int. Cl. G06F 17/60

(52) U.S. Cl. 705/35

(57) ABSTRACT

The present invention relates to a method and system for restructuring a debt instrument without retiring the underlying debt in order to obtain favorable accounting treatment. In particular, the method allows long-term, fixed-rate tax exempt bonds to be refinanced without actually retiring the existing bonds.

### CROSS-REFERENCE TO RELATED APPLICATIONS

This application claims the benefit of U.S. Provisional Application No. 60/425,887, filed Nov. 13, 2002, which is incorporated herein by reference.

### BACKGROUND OF THE INVENTION

1. Field of the Invention

The present invention relates to an alternative structure for achieving the benefits of refinancing long-term, fixed-rate, tax-exempt bonds without actually retiring the existing bonds.

2. Description of the Prior Art

Normally bonds are available for purchase pursuant to debt instrument or trust indentures. Such debt instruments normally include terms for purchase of such bonds and the redemption of the bonds. Redemption of such bonds may result in unfavorable accounting treatment. Thus, there is a need for a method for restructuring the debt while at the same time maintaining the benefits of the debt instruments.

### SUMMARY

The present invention relates to a method and system for restructuring a debt instrument in order to obtain favorable accounting treatment. In particular, the method allows long-term, fixed-rate tax exempt bonds to be refinanced without actually retiring the existing bonds.

### BRIEF DESCRIPTION OF THE DRAWINGS

These and other advantages of the present invention will be readily understood with reference to the following specification and attached drawings wherein:

FIG. 1 is a block diagram illustrating the amendment, purchase and sale of bonds; and

FIG. 2 is a block diagram of the trust structure; and

FIG. 3 is a block diagram of the total return distribution; and

FIG. 4 is a block diagram of the cash flow hedge.

### DETAILED DESCRIPTION OF THE INVENTION

The transaction in accordance with the present invention includes four (4) steps:

1. Amendment, Purchase and Sale of Bonds

2. Trust Structure

3. Total Return Distribution

4. Cash Flow Hedge

Under this particular structure, XYZ is only involved in steps 1, 3 and 4. A description of step 2 is included as it provides some clarity in explaining to the overall transaction. However, XYZ would have no involvement or obligation under step 2.

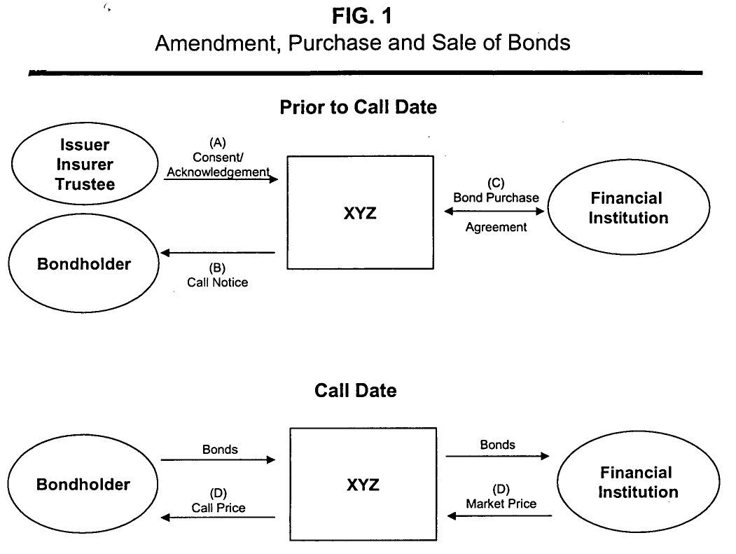

Amendment, Purchase and Sale of Bonds (See FIG. 1).

A. XYZ amends the Trust Indentures of the Bonds to allow a call for purchase in lieu of redemption. The amendment typically requires Issuer, Insurer and Trustee consent/acknowledgement. The amendment does not alter the rights of existing bondholders and has no material impact on the value of the Bonds or the holders of the Bonds. XYZ receives a no adverse effect opinion from bond counsel and certification from Cain Brothers.

B. XYZ calls the Bonds for purchase at a call premium of 102 on the first optional call date. The call notice is made in advance per the requirements of the indenture and XYZ may deposit securities in an escrow account securing the purchase.

C. XYZ signs a Bond Purchase Agreement (“BPA”) with an unrelated third-party Financial Institution which agrees to purchase the Bonds at a market price on the call date. The market price on the call date is equal to par plus the call premium.

D. XYZ purchases the Bonds on the call date and sells them to the Financial Institution under the terms of the BPA.

The terms and conditions of the Bonds are not altered in any way except for the amendment to the call provision. The Bonds remain outstanding at the original coupons and may be called by XYZ for purchase or redemption.

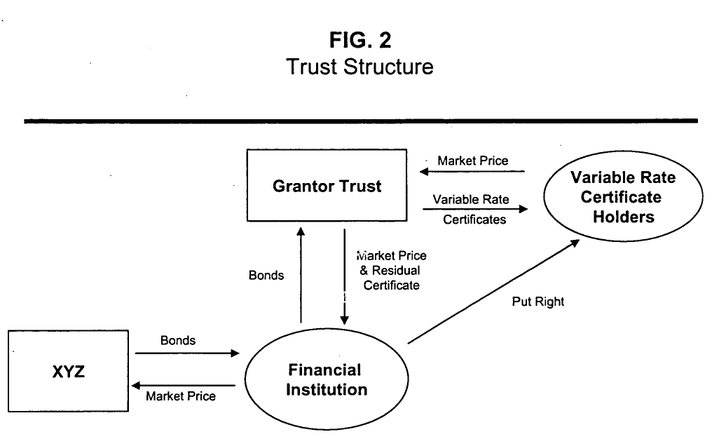

Trust Structure (See FIG. 2).

The Financial Institution purchases the Bonds and subsequently sells the Bonds to a grantor trust which issues two types of certificates:

Variable Certificates

Residual Certificates

The Variable Certificate Holder receives a variable return plus any gain on the sale of the Bonds. The Variable Certificate is repriced weekly. For tax purposes, the Variable Certificates represent ownership interest in the Bonds and the income to the holder is tax-exempt. In addition, the Variable Certificate Holders have the right to put their ownership interest back to the trust on a weekly basis at par.

The Residual Certificate Holder receives its share of the interest flowing into the trust plus any excess after the Variable Certificate Holders, Liquidity Provider and Remarketing Agent are paid. The Residual Certificate Holder has a reimbursement agreement with the Liquidity Provider under which they are obligated to cover any loss of the liquidation of the trust.

The Residual Holder and Liquidity Provider may be affiliates of the Financial Institution which purchases the Bonds.

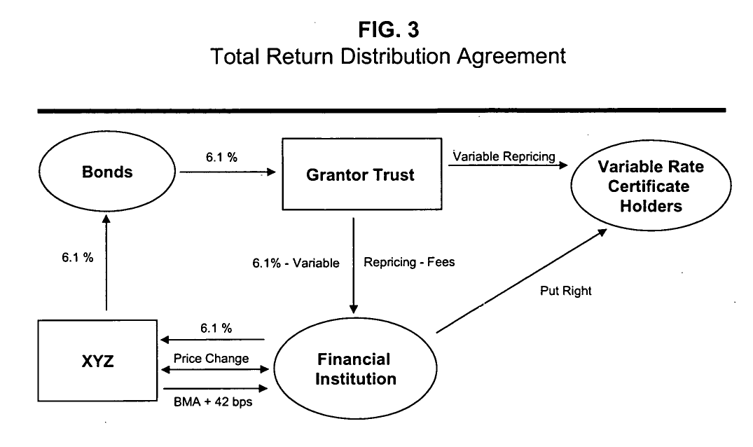

Total Return Distribution (See FIG. 3).

In essence, the Total Return Distribution Agreement passes the Residual Holder's excess cash flow to XYZ in exchange for their agreement to cover the value of the bonds. However, the payment terms under the Total Return Distribution Agreement do not exactly match the Financial Institutions' payment terms under the Trust.

Fifteen days after signing the BPA, XYZ executes a Total Return Distribution Agreement with an affiliate of the Financial Institution purchasing the Bonds with the following terms:

| | |
|---|---|
| Amount: | Same as Bonds Sold |
| Effective Date: | Date of Sale of Bonds |
| Fixed Rate Payor: | Financial Institution |
| Fixed Rate: | Same as Coupon on Bonds |
| Variable Rate Payor: | XYZ |
| Variable Rate: | BMA Index plus 42 bps |
| Payment Dates: | Semiannual |
| Total Return Payment | |
| Financial Institution: | 100% of Gain in Value of Bonds |
| Client: | 100% of loss in Value of Bonds |
| Total Return Payment Date: | Termination Date |
| Termination Date: | Maturity of Bonds |
| Early Termination: | Credit Event or 30 days notice from either |
| | party |

In essence, the Total Return Distribution Agreement passes the Residual Holder's excess cash flow to XYZ in exchange for their agreement to cover the value of the bonds. However, the payment terms under the Total Return Distribution Agreement do not exactly match the Financial Institutions' payment terms under the Trust.

If interest rates increase such that the market value of the Bonds goes below par, it is likely that XYZ will terminate the Total Return Distribution Agreement. At that point in time, the Financial Institution has no right to put the Bonds to XYZ, however, XYZ may call the Bonds at its discretion.

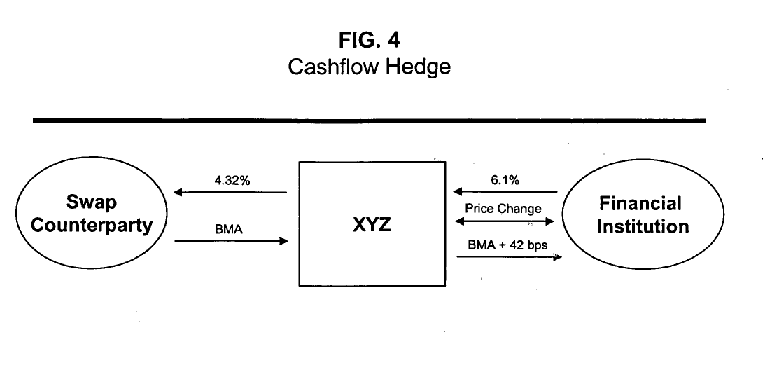

Cash Flow Hedge (See FIG. 4)

The terms of the Total Return Distribution Agreement introduce variable index interest rate risk to XYZ's income statement. In an effort to reduce this risk, XYZ may execute an exemplary cash flow hedge with the following terms:

| | |
|---|---|
| Amount: | Same as Bonds Sold |
| Effective Date: | Same as Call and Sale Date |
| Fixed Rate Payor: | XYZ |
| Fixed Rate: | 4.32% |
| Variable Rate Payor: | Swap Counterparty |
| Variable Rate: | BMA |
| Payment Dates: | Semiannual |
| Termination Date: | Same as Maturity of Bonds |

The fixed pay swap is an effective hedge of the cash flow volatility from the Total Return Distribution Agreement.

There are four accounting issues that need to be addressed.

Treatment of unamortized issuance costs of the Bonds.

FASB Statement No. 140 states that: A debtor shall derecognize a liability if and only if it has been extinguished. A liability has been extinguished if the debtor pays the creditor and is relieved of its obligation for the liability. Paying the creditor includes delivery of cash, other financial assets, goods, or services or reacquisition by the debtor of its outstanding debt securities whether the securities are cancelled or held as so-called treasury bonds.

This statement implies that XYZ will treat the Bonds as if they are considered extinguished and will recognize these costs as a Loss on the Early Extinguishment of Debt. This loss may be recognized above or below Net Operating Income depending on your accounting policies and FASB pronouncements.

Note: The same treatment would apply if XYZ were to refund the Bonds.

Treatment of the sale of the Bonds to the Financial Institution and subsequent execution of the Total Return Distribution.

Viewed in isolation, the sale of the Bonds to a third party has all the characteristics of a True Sale. However, execution of the Total Return Distribution seems to cloud the issue. FASB Statements No. 90, 94, 96, 97 and 140 provide guidance in evaluating the treatment of transactions where assets or liabilities are moved to Special Purpose Entities. Although much of it relates to leasing transactions, it is relevant for this analysis.

When viewing the transaction in aggregate, there is a view that the Financial Institution does not assume the substantial risks and rewards of ownership of the assets of the trust. Consequently, the financial position and operating performance of the trust may be consolidated in XYZ's financial statements. The net impact is that the Bonds are carried on the balance sheet as Treasury Bonds, offsetting the original liability, and a new variable rate liability is created. The amount of outstanding debt remains the same and the interest rate on the new liability is treated as a variable interest rate as opposed to a fixed rate.

Treatment of the costs incurred to restructure the Bonds.

These costs should be amortized over the remaining life of the Bonds just as they would be with a refunding of the Bonds.

Treatment of the variable interest rate cash flow hedge.

The Total Return Distribution introduces variable index interest rate exposure. If XYZ elects to hedge this exposure, FASB Statement No. 133 addresses the accounting for the hedge. Changes in the market value of the variable-to-fixed interest rate swap will be reported on XYZ's financial statements. Where it is reported depends on whether it qualifies as a cash flow hedge under FASB 133. The variable receipt rate on the variable-to-fixed interest rate swap will be highly (potentially perfectly) correlated with the variable index payment on the Total Return Distribution. Consequently, we believe it does qualify as an effective cash flow hedge under FASB Statement No. 133. If the variable-to-fixed interest rate swap is a qualified hedge, all changes in market value (unrealized gains and losses) will be reported below Net Operating Income in Other Changes in Net Assets.

While the invention has been discussed in terms of preferred and specific embodiments, it should be appreciated by those of skill in the art that the invention is not so limited. The embodiments are explained herein by way of example, and there are numerous modifications, variations and other embodiments that may be employed that would still be within the scope of the present invention.

What is claimed is:

1. A method of restructuring a debt instrument without retiring the underlying debt comprising the steps of:
(a) amending a debt instrument to call for purchase of the bonds in lieu of redemption; and
(b) purchasing the bonds for resale to a financial institution pursuant to a purchase agreement.
